(19) United States
(12) Patent Application Publication
(10) Pub. No.: US 2025/0078327 A1
(43) Pub. Date: Mar. 6, 2025

(54) UTILIZING INDIVIDUAL-CONCEPT TEXT-IMAGE ALIGNMENT TO ENHANCE COMPOSITIONAL CAPACITY OF TEXT-TO-IMAGE MODELS

(71) Applicant: Adobe Inc., San Jose, CA (US)

(72) Inventors: Zhipeng Bao, Pittsburgh, PA (US); Yijun Li, Seattle, WA (US); Krishna Kumar Singh, San Jose, CA (US)

(21) Appl. No.: 18/457,895

(22) Filed: Aug. 29, 2023

(51) Int. Cl. G06T 11/00; G06V 10/82

(52) U.S. Cl. CPC G06T 11/00; G06V 10/82

(57) ABSTRACT

The present disclosure relates to systems, methods, and non-transitory computer-readable media that utilize a text-image alignment loss to train a diffusion model to generate digital images from input text. In particular, in some embodiments, the disclosed systems generate a prompt noise representation form a text prompt with a first text concept and a second text concept using a denoising step of a diffusion neural network. Further, in some embodiments, the disclosed systems generate a first concept noise representation from the first text concept and a second concept noise representation from the second text concept. Moreover, the disclosed systems combine the first and second concept noise representation to generate a combined concept noise representation. Accordingly, in some embodiments, by comparing the combined concept noise representation and the prompt noise representation, the disclosed systems modify parameters of the diffusion neural network.

### BACKGROUND

Recent years have seen significant advancement in hardware and software platforms for text-to-image synthesis. For example, many software platforms utilize generative models to create images conditioned on free-form text inputs. Further, many of these generative models create plausible images from text description inputs. However, despite these advancements, existing software platform systems with generative models continue to suffer from a variety of problems with regard to computational accuracy and operational flexibility of implementing computing devices.

### SUMMARY

One or more embodiments described herein provide benefits and/or solve one or more of the problems in the art with systems, methods, and non-transitory computer-readable media that utilize a text-image alignment loss to train a diffusion model to generate higher-quality digital images. For instance, the disclosed systems implement lightweight finetuning during the training process of a diffusion neural network utilizing a text-to-alignment loss to enhance generation of a text-conditioned image with multiple text concepts. In some embodiments, the disclosed systems generate a prompt noise representation from a text prompt that contains multiple concepts. Furthermore, the disclosed systems generate individual concept noise representations for each of the multiple concepts within the text prompt. Moreover, the disclosed systems generate a combined concept noise representation by combining the individual concept noise representations and compares the combined concept noise representation with the prompt noise representation. In one or more embodiments, the disclosed systems modify parameters based on the comparison.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a text-to-image enhancement system operates in accordance with one or more embodiments;

FIG. 2 illustrates an overview of the text-to-image enhancement system generating various noise representations to determine a measure of loss in accordance with one or more embodiments;

FIG. 3 illustrates a diagram of the text-to-image enhancement system training a diffusion neural network in accordance with one or more embodiments;

FIG. 4 illustrates a diagram of the text-to-image enhancement system conditioning a denoising neural network of a diffusion neural network to generate various noise representations in accordance with one or more embodiments;

FIG. 5 illustrates a diagram of the text-to-image enhancement system utilizing a training diffusion neural network and a static diffusion neural network in accordance with one or more embodiments;

FIG. 6 illustrates a diagram of the text-to-image enhancement system implementing a trained diffusion neural network in accordance with one or more embodiments;

FIG. 7 illustrates example results of a comparison between text-conditioned images generated by the text-to-image enhancement system and prior methods in accordance with one or more embodiments;

FIG. 8 illustrates an example schematic diagram of the attention image synthesis system in accordance with one or more embodiments;

FIG. 9 illustrates a flowchart of a series of acts for generating a text-conditioned image in accordance with one or more embodiments;

FIG. 10 illustrates a block diagram of an exemplary computing device in accordance with one or more embodiments.

### DETAILED DESCRIPTION

This disclosure describes one or more implementations of a text-to-image enhancement system that utilizes a text-image alignment loss to train a diffusion neural network to synthesize higher-quality images. For example, the text-to-image enhancement system includes a text-to-image diffusion neural network for generating text-conditioned images that preserves multiple text concepts from a text prompt. As mentioned above, conventional systems suffer from a number of issues in relation to computational inaccuracy and operational inflexibility. For example, conventional systems suffer from computational inaccuracies when generating text-conditioned images from a text prompt with multiple concepts. For instance, conventional systems often generate text-conditioned images missing some of the concepts included within the text prompt. Specifically, conventional systems struggle to preserve more than one concept within a text-conditioned image.

Relatedly, certain conventional systems suffer from operational inflexibility. Indeed, for reasons similar to those described in relation to the inaccuracies of some prior systems, many prior systems are also rigidly limited to generating text-conditioned images with only a single concept. In particular, because some conventional text-image generation systems are unable to distinguish between multiple concepts (e.g., ignores some concepts in the final generation) and are unable to retain concepts across the generation process, conventional systems are limited in operational flexibility.

Furthermore, conventional systems struggle with generating text-conditioned images with varying attributes. In particular, conventional systems struggle with diversifying attributes such as shape, size, and color. As a result, conventional systems suffer from generating text-conditioned images with a similar look and feel (e.g., there is little variation between generated images). Specifically, conventional systems struggle with diversifying attributes due to issues such as model collapse (e.g., concepts collapsing together) and instability that occurs during the training of generative models (e.g., resulting in a lack of diversified images). In other words, conventional systems struggle to capture all the necessary visual concepts mentioned in a text prompt. Further, conventional systems fail to understand both the entire prompt and individual linguistic concepts to combine them and generate novel objects not seen in the training data.

As mentioned, in some embodiments the text-to-image enhancement system modifies parameters of a diffusion neural network to perform text-to-image synthesis. For example, the text-to-image enhancement system implements a diffusion neural network which generates a high-resolution, high-quality image by iteratively refining noise using a diffusion process. In particular, in some embodiments the text-to-image enhancement system implements a text-image alignment loss that enforces the latent vector of a target prompt containing all the information for each object/scene in the prompt. Furthermore, in some embodiments the text-to-image enhancement system demonstrates improved quantitative and qualitative results relative to conventional systems.

As mentioned, in some embodiments, the text-to-image enhancement system processes a text prompt that contains multiple concepts (e.g., a first text concept, a second text concept, and a Kth text concept). For example, the text-to-image enhancement system receives the text prompt as a whole and also parses the text prompt into a set of prompts. In some such embodiments, the text-to-image enhancement system analyzes the text prompt for understanding the entire text prompt and also analyzes individual linguistic concepts to understand the text prompt's constituent components.

In one or more embodiments, the text-to-image enhancement system selects a denoising step of the diffusion neural network to generate noise representations. For instance, the text-to-image enhancement system randomly selects a denoising step from a plurality of denoising steps to generate a prompt noise representation to compare against a combined concept noise representation. In such embodiments, the text-to-image enhancement system modifies parameters of the specifically selected denoising step. Moreover, the text-to-image enhancement system limits modifying parameters to the specifically selected denoising step by applying a stop gradient operation.

In one or more embodiments, the text-to-image enhancement system generates noise representations for each concept within a text prompt. Specifically, the text-to-image enhancement system utilizes a diffusion neural network to generate a first concept noise representation and a second concept noise representation and combines the concept noise representations. Moreover, in some embodiments, the text-to-image enhancement system utilizes a separate diffusion neural network (e.g., a static diffusion neural network) to generate the combined concept noise representation (e.g., and another training diffusion neural network to generate the prompt noise representation).

In one or more embodiments, the text-to-image enhancement system selects multiple denoising steps from a plurality of denoising steps. In particular, in some embodiments the text-to-image enhancement system determines a measure of loss for each selected denoising step and modifies parameters for each of the corresponding denoising steps. In some such embodiments, the text-to-image enhancement system finetunes the overall generation of text-conditioned images by backpropagating the determined measure of loss to each of the selected denoising steps.

Moreover, in one or more embodiments, during implementation of the trained diffusion neural network, the text-to-image enhancement system receives text prompts from a client device. Specifically, the text-to-image enhancement system receives text prompts with multiple concepts from the client device and generates text-conditioned images. For instance, the text-to-image enhancement system generates text-conditioned images in a high-quality manner that preserves the multiple text concepts included within the text prompt.

As suggested, in one or more embodiments, the text-to-image enhancement system provides several advantages over conventional systems. For example, in one or more embodiments, the text-to-image enhancement system improves accuracy over prior systems. For example, as mentioned, the text-to-image enhancement system generates a prompt noise representation from the text prompt and generates concept noise representations (e.g., a first concept noise representation and a second concept noise representation). In particular, in one or more embodiments, the text-to-image enhancement system further combines the concept noise representations to generate a combined concept noise representation and compares it with the prompt noise representation to modify parameters of a diffusion neural network. In doing so, the text-to-image enhancement system improves issues related to inaccurate composition of a text-conditioned image. In particular, the text-to-image enhancement system accurately generates text-conditioned images that preserves multiple concepts within a text prompt by breaking up the text prompt into a set of prompts and comparing the set of prompts with the text prompt as a whole.

In addition to accuracy improvements, in one or more embodiments, the text-to-image enhancement system improves operational flexibility over prior systems. For reasons similar to those described in relation to the accuracy improvements, the text-to-image enhancement system can flexibly adapt the generation of text-conditioned images even for text prompts containing multiple concepts (including object, style, shape, size, and/or color concepts). Thus, in contrast to some prior systems that are rigidly fixed to generating text-conditioned images with a single concept, in one or more embodiments, the text-to-image enhancement system has a diverse capability to retain multiple concepts from a text query in the generation of a high-quality and accurate text-conditioned image.

Moreover, in one or more embodiments, due to the text-to-image enhancement system modifying parameters of the diffusion neural network from a text-image alignment loss (e.g., comparing the combined concept noise representation with the prompt noise representation to determine a measure of loss), the text-to-image enhancement system further enhances the generation of text-conditioned images. For instance, the text-to-image enhancement system generates diverse, high-quality samples by finetuning various denoising steps within a diffusion neural network. Specifically, the text-to-image enhancement system selects a denoising step of the diffusion neural network, determines a measure of loss for the denoising step, and modifies parameters of the selected denoising step. In doing so, at run-time, the diffusion neural network contains finetuned denoising steps to more accurately generate a text-conditioned image with multiple concepts.

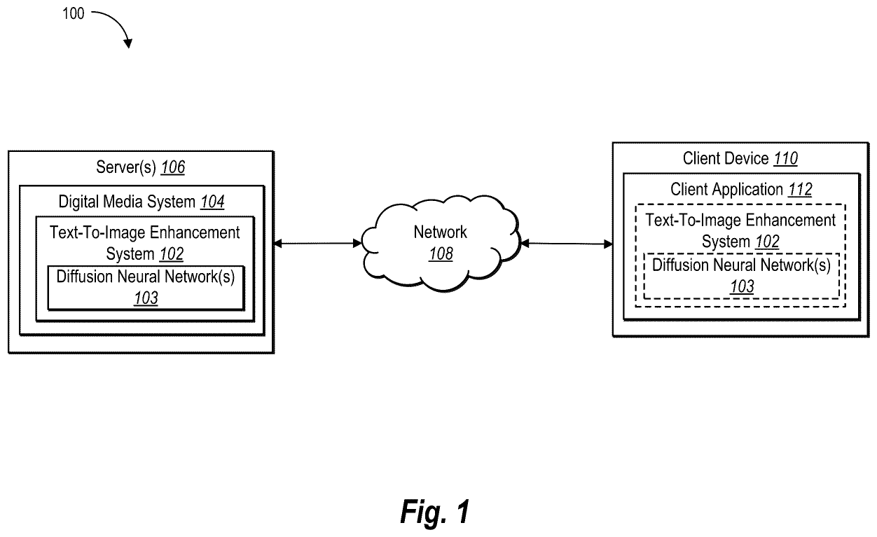

Additional detail regarding the text-to-image enhancement system will now be provided with reference to the figures. For example, FIG. 1 illustrates a schematic diagram of an exemplary system environment 100 in which a text-to-image enhancement system 102 operates. As illustrated in FIG. 1, the system environment 100 includes a server(s) 106, a digital media system 104, diffusion neural network(s) 103, a network 108, a client device 110, and a client application 112.

Although the system environment 100 of FIG. 1 is depicted as having a particular number of components, the system environment 100 is capable of having a different number of additional or alternative components (e.g., a different number of servers, client devices, or other components in communication with the text-to-image enhancement system 102 via the network 108). Similarly, although FIG. 1 illustrates a particular arrangement of the server(s) 106, the network 108, and the client device 110, various additional arrangements are possible.

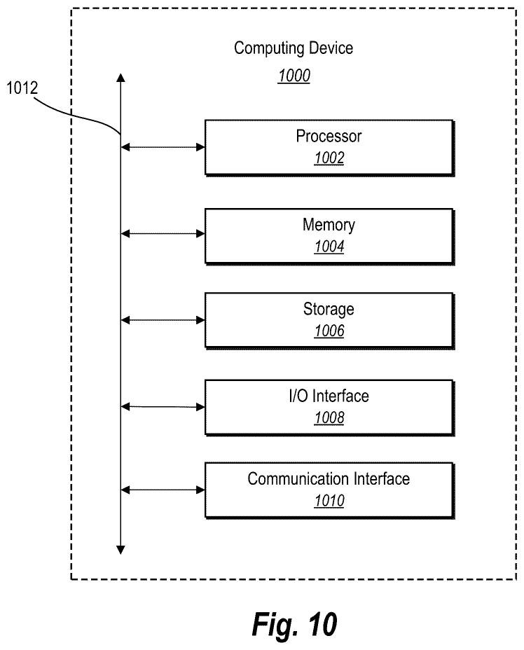

The server(s) 106, the network 108, and the client device 110 are communicatively coupled with each other either directly or indirectly (e.g., through the network 108 discussed in greater detail below in relation to FIG. 10). Moreover, the server(s) 106 and the client device 110 include one or more of a variety of computing devices (including one or more computing devices as discussed in greater detail in relation to FIG. 10).

In one or more embodiments, the text-to-image enhancement system 102 trains the diffusion neural network(s) 103 by finetuning various denoising steps (e.g., during a finetuning training process after an initial training process of the diffusional neural network). For instance, the text-to-image enhancement system 102 trains the diffusion neural network(s) 103 and stores a trained diffusion neural network for the client device 110 to download. Furthermore, in some embodiments, the text-to-image enhancement system 102 stores multiple diffusion neural networks (e.g., a combination of trained and static diffusion neural networks).

As mentioned above, the system environment 100 includes the server(s) 106. In one or more embodiments, the server(s) 106 processes text prompts from a user of the client application 112 to generate a text-conditioned image. In one or more embodiments, the server(s) 106 comprises a data server. In some implementations, the server(s) 106 comprises a communication server or a web-hosting server.

In one or more embodiments, the client device 110 includes a computing device that is able to generate and/or provide, for display, a text-conditioned image on the client application 112. For example, the client device 110 includes smartphones, tablets, desktop computers, laptop computers, head-mounted-display devices, or other electronic devices. The client device 110 includes one or more applications (e.g., an image generation application) for processing text prompts in accordance with the digital media system 104. For example, in one or more embodiments, the client application 112 works in tandem with the text-to-image enhancement system 102 to process text prompts utilizing the diffusion neural network(s) 103 to generate text-conditioned images. In particular, the client application 112 includes a software application installed on the client device 110. Additionally, or alternatively, the client application 112 of the client device 110 includes a software application hosted on the server(s) 106 which may be accessed by the client device 110 through another application, such as a web browser.

To provide an example implementation, in some embodiments, the text-to-image enhancement system 102 on the server(s) 106 supports the text-to-image enhancement system 102 on the client device 110. For instance, in some cases, the digital media system 104 on the server(s) 106 gathers data for the text-to-image enhancement system 102. In response, the text-to-image enhancement system 102, via the server(s) 106, provides the information to the client device 110. In other words, the client device 110 obtains (e.g., downloads) the text-to-image enhancement system 102 from the server(s) 106. In some embodiments, once downloaded, the text-to-image enhancement system 102 on the client device 110 trains (and utilizes) the diffusion neural network(s) 103. While in some embodiments, the text-to-image enhancement system 102 trains the diffusion neural network(s) 103 prior to providing the diffusion neural network(s) 103 to the client device 110.

In alternative implementations, the text-to-image enhancement system 102 includes a web hosting application that allows the client device 110 to interact with content and services hosted on the server(s) 106. To illustrate, in one or more implementations, the client device 110 accesses a software application supported by the server(s) 106. In response, the text-to-image enhancement system 102 on the server(s) 106, trains the diffusion neural network(s) 103 and generates text-conditioned images at inference time. The server(s) 106 then provides the text conditioned image to the client device 110 for display.

To illustrate, in some cases, the text-to-image enhancement system 102 on the client device 110 receives a text prompt that includes multiple concepts. The client device 110 transmits the text prompt with the multiple concepts to the server(s) 106. In response, the text-to-image enhancement system 102 on the server(s) 106 utilizes the diffusion neural network(s) 103 to generate a text-conditioned image.

Indeed, in some embodiments, the text-to-image enhancement system 102 is implemented in whole, or in part, by the individual elements of the system environment 100. For instance, although FIG. 1 illustrates the text-to-image enhancement system 102 implemented or hosted on the server(s) 106, different components of the text-to-image enhancement system 102 are able to be implemented by a variety of devices within the system environment 100. For example, one or more (or all) components of the text-to-image enhancement system 102 are implemented by a different computing device (e.g., the client device 110) or a separate server from the server(s) 106. Indeed, as shown in FIG. 1, the client device 110 includes the text-to-image enhancement system 102. Example components of the text-to-image enhancement system 102 will be described below with regard to FIG. 10.

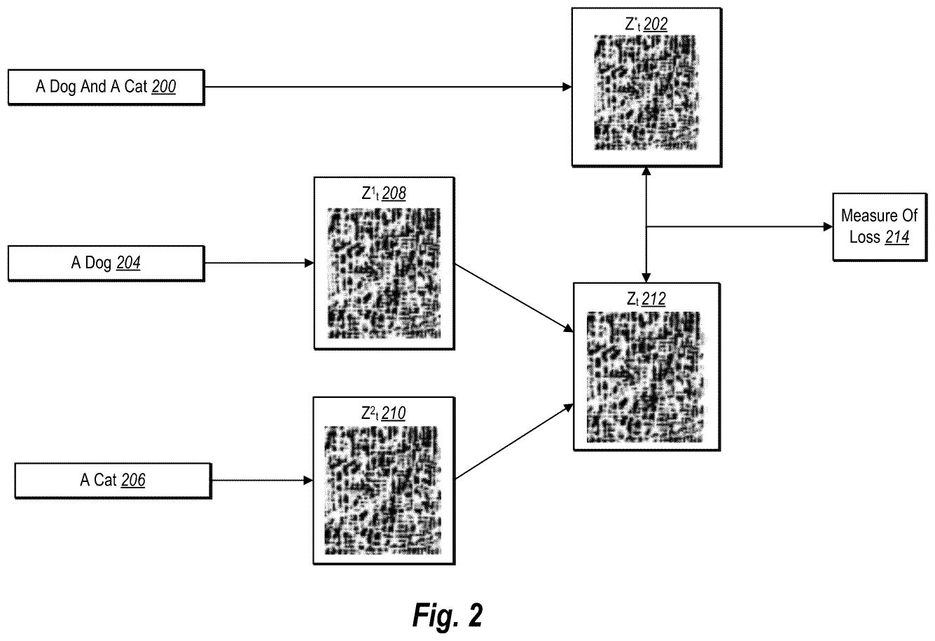

As mentioned above, in certain embodiments, the text-to-image enhancement system 102 compares a prompt noise representation with a combined concept noise representation. FIG. 2 illustrates an overview of the text-to-image enhancement system 102 determining a measure of loss between a prompt noise representation and a combined concept noise representation in accordance with one or more embodiments.

For example, FIG. 2 shows the text-to-image enhancement system 102 processing a text prompt 200. In particular, FIG. 2 shows the text prompt 200 as reading “a dog and a cat.” In particular, the text-to-image enhancement system 102 receives the text prompt 200 with multiple concepts for training purposes (e.g., training denoising steps of a diffusion neural network). In some embodiments, the text-to-image enhancement system 102 receives the text prompt 200 from a client device during implementation of a trained diffusion neural network.

Specifically, the text prompt 200 with multiple concepts indicates to the text-to-image enhancement system 102 to generate an image that includes the multiple concepts. For instance, a concept includes an idea that represents a category, class, characteristic, or feature. Thus, the term concept includes an object, style, shape, color, or other class or characteristic to include in a generated digital image. To illustrate, for the text prompt 200 “a dog and a cat,” the text prompt 200 includes the concepts of “a dog,” and “a cat.”

Moreover, FIG. 2 shows the text-to-image enhancement system 102 generating a noise representation from the text prompt 200. In one or more embodiments, the noise representation includes the addition of random noise as input data. For instance, the noise representation includes Gaussian noise sampled from a normal distribution with a mean of zero and a specified standard deviation. The text-to-image enhancement system 102, by utilizing a diffusion neural network, processes the noise representation to generate a text-conditioned image.

Specifically, FIG. 2 shows the text-to-image enhancement system 102 generating a prompt noise representation 202 from the text prompt 200. In one or more embodiments, the text-to-image enhancement system 102 utilizes a diffusion neural network to generate the prompt noise representation 202. For instance, the prompt noise representation 202 includes a noise representation where the text-to-image enhancement system 102 conditions the denoising layer with the text prompt as a whole (e.g., the text prompt with all the concepts).

FIG. 2 further shows the text prompt 200 broken up into individual text concepts. For instance, FIG. 2 shows a first text concept 204 (e.g., a dog) and a second text concept 206 (e.g., a cat). From the first text concept 204, the text-to-image enhancement system 102 generates a first concept noise representation 208 and from the second text concept, the text-to-image enhancement system 102 generates a second concept noise representation 210.

Further, in some embodiments, the text-to-image enhancement system 102 utilizes a diffusion neural network to generate the first concept noise representation 208 and the second concept noise representation 210. Specifically, the first concept noise representation 208 includes a noise representation where the text-to-image enhancement system 102 conditions the denoising layer with the first text concept 204 of the text prompt 200. Similarly, the second concept noise representation 210 includes a noise representation where the text-to-image enhancement system 102 conditions the denoising layer with the second text concept 206 of the text prompt 200.

Moreover, FIG. 2 shows the text-to-image enhancement system 102 generating a combined concept noise representation 212 from the first concept noise representation 208 and the second concept noise representation 210. For instance, the text-to-image enhancement system 102 combines the first concept noise representation 208 and the second concept noise representation 210 (e.g., by performing a summation operation or another combination operation such as a multiplication operation). In particular, the summation operation adds together each of the individual concept noise representations.

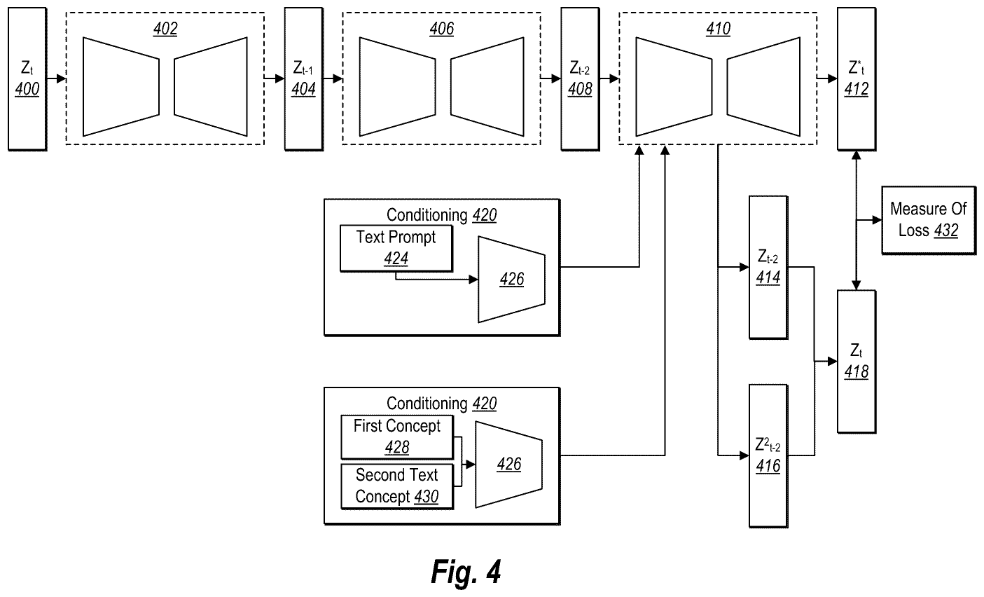

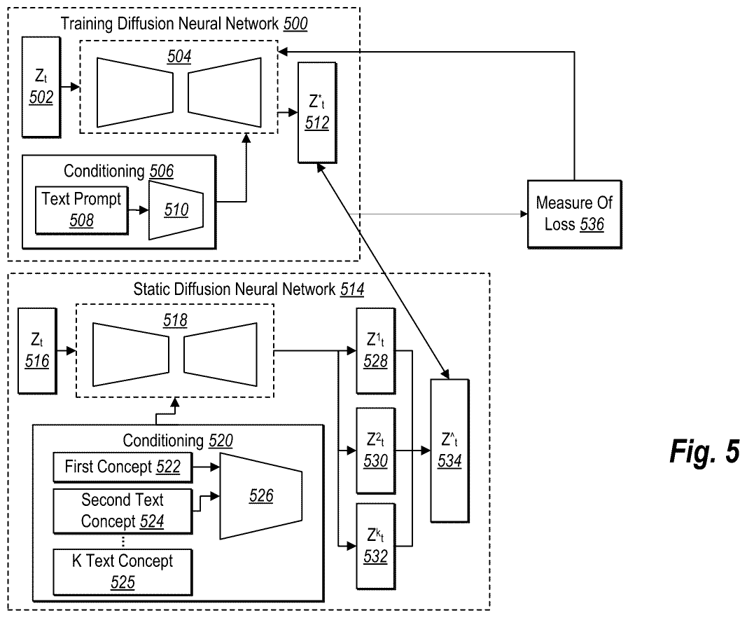

Furthermore, FIG. 2 shows the text-to-image enhancement system 102 determining a measure of loss 214 by comparing the combined concept noise representation 212 with the prompt noise representation 202. For instance, the text-to-image enhancement system 102 determines the measure of loss 214 to backpropagate through one or more denoising layers. Additional details of the measure of loss 214 are given below in the description of FIGS. 4 and 5.

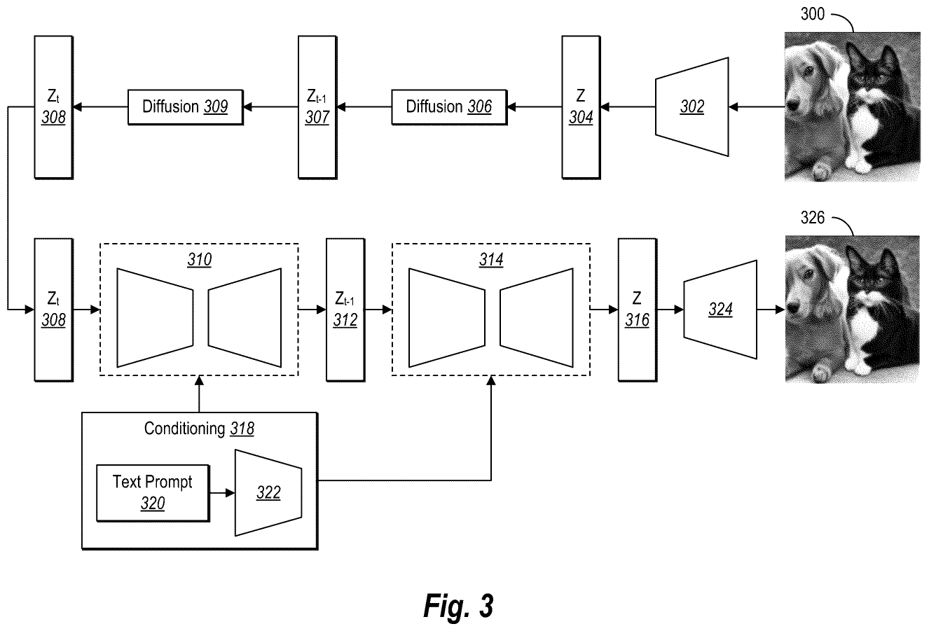

As discussed above, the text-to-image enhancement system 102 can train and utilize a diffusion neural network. FIG. 3 shows the text-to-image enhancement system 102 training a diffusion neural network by adding noise to a digital image and a series of denoising steps to reconstruct the input digital image in accordance with one or more embodiments.

As mentioned above, in one or more embodiments, the text-to-image enhancement system 102 utilizes various types of machine learning models. For example, FIG. 3 illustrates the text-to-image enhancement system 102 utilizing a diffusion neural network (also referred to as a “diffusion model” a “diffusion probabilistic model” or “denoising diffusion probabilistic model”) to generate a text-conditioned image in accordance with one or more embodiments. In particular, FIG. 3 illustrates the diffusion neural network generating a text-conditioned image 326 while the subsequent figures illustrate finetuning a denoising portion of the diffusion neural network.

As mentioned above, the text-to-image enhancement system 102 utilizes a diffusion neural network. In particular, a diffusion neural network receives as input a digital image 300 and adds noise to the digital image 300 through a series of steps (e.g., diffusion step 306 and diffusion step 309). For instance, the text-to-image enhancement system 102 via the diffusion neural network diffuses the digital image 300 utilizing a fixed Markov chain that adds noise to the data of the digital image 300. Furthermore, each step of the fixed Markov chain relies upon the previous step. Specifically, at each step (e.g., diffusion step 306 and diffusion step 309), the fixed Markov chain adds Gaussian noise with variance, which produces a diffusion representation (e.g., diffusion latent vector, a diffusion noise map, or a diffusion inversion). Subsequent to adding noise to the digital image 300 at various steps of the diffusion neural network, the text-to-image enhancement system 102 utilizes a denoising neural network to recover the original data from the digital image 300. Specifically, the text-to-image enhancement system 102 utilizes steps of a denoising neural network (e.g., denoising neural network 310 step and denoising neural network 314 step) with a length T equal to the length of the fixed Markov chain to reverse the process of the fixed Markov chain.

FIG. 3 illustrates the text-to-image enhancement system 102 training a diffusion neural network to generate the text-conditioned image 326. In particular, FIG. 3 illustrates the text-to-image enhancement system 102 analyzing the digital image 300 to generate the text-conditioned image 326 (e.g., a reconstruction of the digital image 300 conditioned on a text prompt 320). Specifically, the text-to-image enhancement system 102 utilizes the diffusion process (e.g., diffusion step 306 and diffusion step 309) during training to generate various diffusion representations, culminating in a final diffusion representation that is passed to the denoising neural network 310. The text-to-image enhancement system 102, during training, supervises the output of each denoising neural network layer based on the diffusion representations generated during the diffusion process.

As illustrated, FIG. 3 shows the text-to-image enhancement system 102 utilizing an encoder 302 to generate a latent vector 304 (e.g., a diffusion representation) from the digital image 300. In one or more embodiments, the encoder 302 is a neural network (or one or more layers of a neural network) that extract features relating to the digital image 300, e.g., in this instance relating to different concepts depicted within the digital image 300. In some cases, the encoder 302 includes a neural network that encodes features from the digital image 300. For example, the encoder 302 can include a particular number of layers including one or more fully connected and/or partially connected layers that identify and represent characteristics/features of the digital image 300 through a latent feature vector. Thus, the latent vector 304 includes a hidden (e.g., indecipherable to humans) vector representation of the digital image 300. Specifically, the latent vector 304 includes a numerical representation of features of the digital image 300.

Furthermore, FIG. 3 illustrates the diffusion process of the diffusion neural network. In particular, FIG. 3 shows a diffusion of the latent vector 304. At each step (based on the fixed Markov chain) of the diffusion process, the text-to-image enhancement system 102 via the diffusion neural network generates a diffusion representation. For instance, the diffusion process adds noise to the diffusion representation at each step until the diffusion representation is diffused, destroyed, or replaced. Specifically, the text-to-image enhancement system 102 via the diffusion process adds Gaussian noise to the signal of the latent vector 304 utilizing a fixed Markov Chain to generate an additional latent vector 307. As shown, the text-to-image enhancement system 102 further generates a final latent vector 308 (e.g., a final diffusion representation). Moreover, although FIG. 3 illustrates performing the diffusion process with the latent vector 304, in some embodiments, the text-to-image enhancement system 102 applies the diffusion process to pixels of the digital image (without generating a latent vector representation of the digital image).

As just mentioned, the diffusion process adds noise at each step of the diffusion process. Indeed, at each diffusion step, the diffusion process adds noise and generates a diffusion representation. Thus, for a diffusion process with five diffusion steps, the diffusion process generates five diffusion representations. As shown in FIG. 3 the text-to-image enhancement system 102 generates the final latent vector 308. In particular, in FIG. 3, the final latent vector 308 comprises random Gaussian noise after the completion of the diffusion process. As part of the diffusion neural network, the denoising neural network denoises the final latent vector 308 (e.g., reverses the process of adding noise to the diffusion representation performed by the diffusion process).

As shown, FIG. 3 illustrates the denoising neural network 310 generating a first denoised representation 312 that partially denoises the final latent vector 308 by generating the first denoised representation 312. Furthermore, FIG. 3 also illustrates the denoising neural network 314 receiving the first denoised representation 312 for further denoising to generate a second denoised representation 316. In particular, in one or more embodiments the number of denoising steps corresponds with the number of diffusion steps (e.g., of the fixed Markov chain).

Moreover, FIG. 3 shows the text-to-image enhancement system 102 conditioning the denoising neural network 310 and the denoising neural network 314. In particular, FIG. 3 shows the text-to-image enhancement system 102 performing an act 318 of conditioning the denoising neural networks utilizing a text prompt 320. For instance, the text-to-image enhancement system 102 processes the text prompt 320 with a text encoder 322 to generate a text prompt embedding. Further, the text-to-image enhancement system 102 utilizes the text prompt embedding to condition various layers of the denoising neural networks. Additional details regarding the act 318 of conditioning is given below in the description of FIGS. 4 and 5.

In one or more embodiments, the text-to-image enhancement system 102 utilizes a conditional input for the stable diffusion model that includes a prompt embedding produced by a CLIP text encoder. For instance, the text-to-image enhancement system 102 implements the CLIP text encoder as described in Alec Radford, Jong Wook Kim, Chris Hallacy, Aditya Ramesh, Gabriel Goh, Sandhini Agarwal, Girish Sastry, Amanda Askell, Pamela Mishkin, Jack Clark, et al. Learning transferable visual models from natural language supervision. In ICML, 202, which is fully incorporated by reference herein.

Furthermore, FIG. 3 illustrates the text-to-image enhancement system 102 processing the second denoised representation 316 with a decoder 324 to generate the text-conditioned image 326. In one or more implementations, the text-to-image enhancement system 102 trains the denoising neural networks in a supervised manner based on the diffusion representations generated at the diffusion process. For example, the text-to-image enhancement system 102 compares (utilizing a loss function) a diffusion representation at a first step of the diffusion process with a final denoised representation generated by the final denoising neural network. Similarly, the text-to-image enhancement system 102 can compare (utilizing a loss function) a second diffusion representation from a second step of the diffusion process with a penultimate denoised representation generated by a penultimate denoising neural network. The text-to-image enhancement system 102 can thus utilize corresponding diffusion representations of the diffusion process to teach or train the denoising neural networks to denoise random Gaussian noise and generate digital images conditioned on the text prompt 320.

For example, in one or more embodiments, the text-to-image enhancement system 102 utilizes a stable diffusion model (or stable diffusion neural network). For instance, in some embodiments, the text-to-image enhancement system 102 implements a stable diffusion model as described by Robin Rombach, Andreas Blattmann, Dominik Lorenz, Patrick Esser, and Bjorn Ommer. High-resolution image synthesis with latent diffusion models. In Proceedings of the IEEE/CVF Conference on Computer Vision and Pattern Recognition, pages 10684-10695, 2022. 1, 2, 3, 4, 5, 7, 8, which is incorporated herein by reference in its entirety.

In one or more embodiments, the text-to-image enhancement system 102 utilizes the stable diffusion model that runs in a latent space of an autoencoder (rather than an image space). In other words, the autoencoder of the stable diffusion model includes a neural network with encoder and decoder components. Further, the autoencoder of the stable diffusion model compresses a digital image into a lower-dimensional representation such as a latent space. Moreover, the autoencoder of the stable diffusion model then reconstructs the compressed digital image.

In one or more embodiments, the text-to-image enhancement system 102 utilizes an autoencoder with an encoder trained to map a given image into a spatial latent code. For instance, the text-to-image enhancement system 102 represents utilizing the encoder as ε, an image as x∈χ, and generating a spatial latent code from the image as z=ε(x). Furthermore, in one or more embodiments, the text-to-image enhancement system 102 utilizes a decoder which is then tasked with reconstructing the input image. In other words, the decoder [symbol] reconstructs the image such that [symbol] (ε(x))≈x.

In one or more embodiments, the text-to-image enhancement system 102 pre-trains a large-scale autoencoder and further trains a denoising diffusion probabilistic model. For instance, the denoising diffusion probabilistic model operates over a learned latent space to produce a denoised version of a noise input zₜ at time step t. Further, in some embodiments, during the denoising process, the text-to-image enhancement system 102 conditions the stable diffusion model with additional input vectors (e.g., obtained from images, text, semantic maps, etc.). To illustrate, the text-to-image enhancement system 102 implements a denoising diffusion probabilistic model as described in Jonathan Ho, Ajay Jain, and Pieter Abbeel. Denoising diffusion probabilistic models. NeurIPS, 202, which is fully incorporated herein by reference.

As mentioned above, in one or more embodiments, the text-to-image enhancement system 102 utilizes a CLIP text encoder to generate a conditional embedding. Further, in some embodiments, given a conditional embedding c(y), conditioned on the text prompt y, the text-to-image enhancement system 102 via the denoising diffusion probabilistic model ϵ_{θ} is trained to minimize the following loss:

$$ℒ = {‖ ϵ - {ϵ}_{θ} ( {z}_{t} , t , c ( y ) ) ‖}^{2} .$$

For instance, the above equation indicates that at each time step t, the denoising diffusion probabilistic model ϵ_{θ} is tasked with correctly removing the noise ϵ added to the latent code z, given the noised latent zₜ, timestep t, and conditioning encoding c(y). Concretely, in some embodiments the text-to-image enhancement system 102 implements the denoising diffusion probabilistic model ϵ_{θ} as a UNet architecture consisting of self-attention and cross-attention layers. To illustrate, in some embodiments, the text-to-image enhancement system 102 implements the denoising diffusion probabilistic model as described in Olaf Ronneberger, Philipp Fischer, and Thomas Brox. U-net: Convolutional networks for biomedical image segmentation. In MICCAI, 2015, which is fully incorporated by reference herein.

In one or more embodiments, the text-to-image enhancement system 102 via the stable diffusion model uses text embedding to guide the generation of a digital image. Specifically, the text-to-image enhancement system 102 generates a digital image guided via cross-attention models. Moreover, in some embodiments, the cross-attention models utilized by the text-to-image enhancement system 102 include a self-attention layer followed by a cross-attention layer in each denoising step. Furthermore, in some embodiments, the cross-attention models operate on resolutions of 64, 32, 16, and 8. Accordingly, in some embodiments the text-to-image enhancement system 102 utilizes a text embedding to guide the image generation as a condition via the cross-attention layers.

In one or more embodiments, a latent vector (e.g., from an ith layer of the UNet) operates as a query of the cross-attention layer and the text embedding. To illustrate, in some embodiments, the text-to-image enhancement system 102 indicates the text embedding as c(y)∈ [symbol] , where N is the length of the text sequence and dₜₑₓₜ is the embedding dimension. Further, the text-to-image enhancement system 102 utilizes the latent vector as the query of the cross-attention layer and the text embedding as the key and value for:

$${z}_{t}^{{i}^{′}} = MHA ( q ( {z}_{t}^{i} ) , k ( c ( y ) ) , v ( c ( y ) ) ) .$$

In the above equation, the text-to-image enhancement system 102 runs an attention operation for a latent vector to obtain attention masks for further processing. In some embodiments, the text-to-image enhancement system 102 indicates the attention masks as Aₜ∈ [symbol] where p∈{64,32,16,8} acts as the spatial resolution of the latent feature.

As mentioned above, in one or more implementations the text-to-image enhancement system 102 utilizes a text-image alignment loss to train a diffusion neural network. FIG. 4 shows the text-to-image enhancement system 102 utilizing the text-image alignment loss at a selected step of the denoising neural network in accordance with one or more embodiments.

In one or more embodiments, the text-to-image enhancement system 102 utilizes a static diffusion neural network and a training diffusion neural network. For instance, in some embodiments the text-to-image enhancement system 102 utilizes a static diffusion neural network to generate concept noise representations. In particular, the static diffusion neural network includes a diffusion neural network where the text-to-image enhancement system 102 does not modify parameters in response to determining a measure of loss. For instance, in some embodiments, the static diffusion neural network includes a diffusion neural network separate from a training diffusion neural network. In some implementations, the text-to-image enhancement system 102 utilizes the training diffusion neural network as the static diffusion neural network (i.e., the same neural network).

For instance, the text-to-image enhancement system 102 utilizes a training diffusion neural network to generate a prompt noise representation. In particular, the training diffusion neural network includes a diffusion neural network where the text-to-image enhancement system 102 modifies parameters in response to determining a measure of loss. For instance, post-training, the text-to-image enhancement system 102 implements the training diffusion neural network for generating text-conditioned images with multiple concepts in response to receiving a text prompt from a client device. FIG. 4 shows a single diffusion neural (e.g., where the static diffusion neural network and the training diffusion neural network are the same) for generating prompt noise representations and concept noise representations. FIG. 5 illustrates an embodiment where static diffusion neural network and training diffusion neural are separate.

As shown, FIG. 4 illustrates an initial noise representation 400, a denoising neural network generating a first noise representation 404 corresponding with a first denoising step 402. Additionally, FIG. 4 also shows a second noise representation 408 from a second denoising step 406. Moreover, FIG. 4 shows the text-to-image enhancement system 102 conditioning a third denoising step 410 to determine a measure of loss (e.g., a text-image alignment loss). As discussed previously in FIG. 2, FIG. 4 shows the text-to-image enhancement system 102 generating a prompt noise representation 412, a first concept noise representation 414, and a second concept noise representation 416.

As shown, FIG. 4 illustrates the text-to-image enhancement system 102 performing an act 420 of conditioning the third denoising step 410 of the denoising neural network. For example, the act 420 includes conditioning each layer of the third denoising step 410. To illustrate, conditioning layers of a neural network includes providing context to the networks to guide the generation of a text-conditioned image. For instance, conditioning layers of neural networks include at least one of (1) transforming conditioning inputs (e.g., the text prompt) into vectors to combine with the denoising representations; and/or (2) utilizing attention mechanisms which causes the neural networks to focus on specific portions of the input and condition its predictions (e.g., outputs) based on the attention mechanisms. Specifically, for denoising neural networks, conditioning layers of the denoising neural networks includes providing an alternative input to the denoising neural networks (e.g., the text query). In particular, the text-to-image enhancement system 102 provides alternative inputs to provide a guide in removing noise from the diffusion representation (e.g., the denoising process). Thus, the text-to-image enhancement system 102 conditioning layers of the denoising neural networks acts as guardrails to allow the denoising neural networks to learn how to remove noise from an input signal and produce a clean output.

Specifically, conditioning the layers of the network includes modifying input into the layers of the denoising neural networks to combine with the noise representation. For instance, the text-to-image enhancement system 102 combines (e.g., concatenates) vector values generated from the encoder at different layers of the denoising neural networks. For instance, the text-to-image enhancement system 102 combines one or more conditioning vectors with the noise representation, or the modified noise representation. Thus, the denoising process considers the noise representation and the text vector representation (e.g., the text prompt) to generate text-conditioned images.

To illustrate, FIG. 4 shows the text-to-image enhancement system 102 conditioning the third denoising step 410 with a text prompt 424, a first text concept 428, and a second text concept 430. Specifically, to condition the third denoising step 410, the text-to-image enhancement system 102 utilizes a text encoder 426.

In one or more embodiments, the text-to-image enhancement system 102 utilizes a text encoder to 426 process the text prompt 424, the first text concept 428, and the second text concept 430. In particular, the text encoder 426 includes a component of a neural network to transform textual data (e.g., the text prompt 424) into a numerical representation. For instance, the text-to-image enhancement system 102 utilizes the text encoder 426 to transform the text into a text vector representation. Further, the text-to-image enhancement system 102 utilizes the text encoder 426 in a variety of ways. For instance, the text-to-image enhancement system 102 utilizes the text encoder 426 to i) determine the frequency of individual words in the text prompt 424 (e.g., each word becomes a feature vector), ii) determines a weight for each word within the text to generate a text vector that captures the importance of words within the text prompt 424, the first text concept 428, and the second text concept 430, iii) generates low-dimensional text vectors in a continuous vector space that represents words within the text prompt 424, the first text concept 428, and the second text concept 430, and/or iv) generates contextualized text vectors by determining semantic relationships between words within the text prompt 424, the first text concept 428, and the second text concept 430.

As mentioned above, the text-to-image enhancement system 102 utilizes the text encoder to generate a text vector representation. In one or more embodiments, the text vector representation includes a numeral representation of the text prompt 424, the first text concept 428, and/or the second text concept 430. In particular, the text-to-image enhancement system 102 generates the text vector representation via a text encoding process and the text vector representation represents various aspects of the text prompt 424, the first text concept 428, or the second text concept 430. For instance, the text vector representation indicates the presence of specific concepts, the meaning of the specific concepts, the relationship between concepts, and the context of the concepts.

As shown in FIG. 4, the text-to-image enhancement system 102 combines the first concept noise representation 414 and the second concept noise representation 416 to generate a combined concept noise representation 418. Furthermore, as shown, the text-to-image enhancement system 102 compares the combined concept noise representation 418 with the prompt noise representation 412 to determine a measure of loss 432. For instance, the text-to-image enhancement system 102 utilizes a loss function to determine the measure of loss 432.

The text-to-image enhancement system 102 can utilize a variety of loss functions in determining the measure of loss 432. To illustrate, loss functions include mean squared error loss (MSE), mean absolute error loss, binary cross-entropy loss, categorical cross-entropy loss, sparse categorical cross-entropy loss, hinge loss, Huber loss, and Kullback-leibler divergence. In some embodiments, the text-to-image enhancement system 102 utilizes an MSE loss function.

As further shown in FIG. 4, the text-to-image enhancement system 102 backpropagates the measure of loss 432 to the third denoising step 410. Moreover, in one or more embodiments, the text-to-image enhancement system 102 (e.g., post backpropagation), selects an additional denoising step of the diffusion neural network from a plurality of denoising steps. In some such embodiments, the text-to-image enhancement system 102 generates, utilizing the additional denoising step, an additional prompt noise representation from an additional text prompt with multiple concepts. Likewise, in such cases, the text-to-image enhancement system 102 also determines a measure of loss to backpropagate to the additional denoising step. Thus, although FIG. 4 illustrates applying a measure of loss to a particular denoising step, the text-to-image enhancement system 102 can utilize the illustrated approach with a plurality of different denoising steps (or a different denoising step).

As mentioned previously, FIG. 5 illustrates a static diffusion neural network and a training diffusion neural network for determining a measure of loss in accordance with one or more embodiments. For example, FIG. 5 shows the text-to-image enhancement system 102 utilizing a training diffusion neural network 500 and a static diffusion neural network 514 as separate neural networks.

Furthermore, FIG. 5 shows the text-to-image enhancement system 102 selecting a different denoising step relative to the denoising step selected in FIG. 4. For instance, FIG. 5 shows the text-to-image enhancement system 102 selecting a first denoising step 504 and 518. Moreover, FIG. 5 shows the text-to-image enhancement system 102 processing a noise representation 502 with the training diffusion neural network 500 conditioned (e.g., by performing an act 506) on a text prompt 508 (e.g., to generate a text embedding vector from the text prompt 508 via a text encoder 510).

Moreover, FIG. 5 shows the text-to-image enhancement system 102 processing a noise representation 516 via the static diffusion neural network 514. For instance, FIG. 5 shows the text-to-image enhancement system 102 conditioning (e.g., performing an act 520) on a first text concept 522 and a second text concept 524 to generate a first concept noise representation 528 and a second concept noise representation 530 (e.g., to generate a text embedding vector via a text encoder 526).

Moreover, in contrast to FIG. 4, FIG. 5 also shows the text-to-image enhancement system 102 generating a K^{th} concept noise representation 532 from a K^{th} text concept 525. Accordingly, FIG. 5 shows the text-to-image enhancement system 102 generating a combined concept noise representation 534 by combining the first concept noise representation 528, the second concept noise representation 530, and the K^{th} concept noise representation 532. Thus, the text-to-image enhancement system 102 determines a measure of loss 536 by comparing the combined concept noise representation 534 with the prompt noise representation 512.

In one or more embodiments, the text-to-image enhancement system 102 receives the text prompt 508 and parses the text prompt 508 to a set of prompts. For instance, the text-to-image enhancement system 102 represents the text prompt 508 as c* and parses c* to a set of prompts {cⁱ}ᵢ₌₁^{K}, where c*=Σᵢ₌₁^{K}cⁱ. Moreover, cⁱ indicates the description of an object or scene and K indicates the number of objects/scenes in the text prompt 508.

In one or more embodiments, given a random latent vector from a final time step, the text-to-image enhancement system 102 obtains a corresponding latent vector conditioned on the text prompt 508. To illustrate, the text-to-image enhancement system 102 represents the random latent vector as z_{T}˜N(z; 0, 1) and the corresponding latent vector as zₜ*, {zₜⁱ}ᵢ₌₁^{K} conditioned on the text prompt 508 c* and {cⁱ}ᵢ₌₁^{K} at time step t. Furthermore, the text-to-image enhancement system 102 represents a target latent vector that contains all the objects/scenes in the text prompt 508 as \hat{z}ₜ=Σᵢzₜⁱ.

As mentioned, in one or more embodiments, the text-to-image enhancement system 102 trains (e.g., finetunes) the denoising steps of the training diffusion neural network 500 by randomly sampling a time step t in the range of [0, T] (e.g., from a plurality of time steps). Furthermore, as mentioned, the text-to-image enhancement system 102 also applies a stop gradient operation on the target latent vector (e.g., the combined concept noise representation 534). In other words, the text-to-image enhancement system 102 utilizes a loss function on the model prediction (e.g., the prompt noise representation 512) based on (c*, z_{T}) and \hat{z}ₜ (e.g., a comparison between the combined concept noise representation 534 and the prompt noise representation 512).

In one or more embodiments, the stop gradient operation includes controlling a gradient flow through specific components of a diffusion neural network during backpropagation. For instance, the text-to-image enhancement system 102 determines a measure of loss by comparing the prompt noise representation 512 with the combined concept noise representation 534 and the stop gradient operation stops the loss from being backpropagated to more than the specific denoising step (e.g., the first denoising step 504 and 518) utilized to generate the noise representations.

For instance, the text-to-image enhancement system 102 utilizes a loss function represented as:

$$L align = {\sum }_{s ∈ S} {‖ {z}_{t}^{*} ( s ) - sg ( {\hat{z}}_{t} ( s ) ) ‖}^{2}$$

In the above equation, S indicates a training batch and sg(⋅) indicates a stop gradient operation. Furthermore, in one or more embodiments, the above equation causes a distribution shift of the training diffusion neural network 500 (e.g., the stable diffusion model trained as described in FIG. 3). In some such embodiments, the text-to-image enhancement system 102 adds a normalization term to optimize the loss function. To illustrate, the normalization term includes:

$$ℒ norm = {\sum }_{i}$$

Where (xⁱ, yⁱ) is a real image-prompt pair queried from the training data corresponding to a parsed sub-prompt cⁱ, e.g., “cat” in “a cat and a mouse in a house. Accordingly, based on the normalization term, the text-to-image enhancement system 102 utilizes a final loss objective represented as:

$${ℒ}_{final} = {λℒ}_{norm} ( x , {c}^{*} ) + {ℒ}_{align} ( {c}^{*} ) .$$

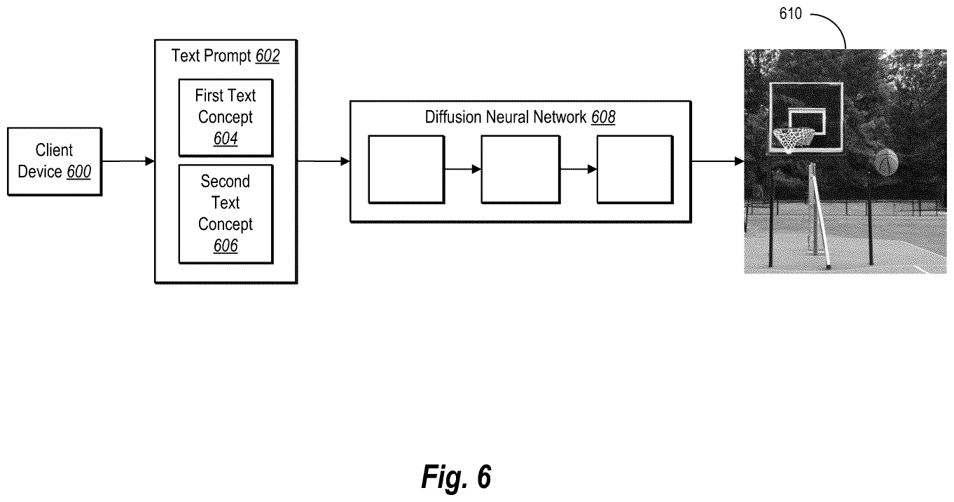

As mentioned above, the text-to-image enhancement system 102 implements a trained diffusion neural network to generate text-conditioned images. For example, FIG. 6 shows the text-to-image enhancement system 102 generating a text-conditioned image 610 using a diffusion neural network in accordance with one or more embodiments.

For example, FIG. 6 shows the text-to-image enhancement system 102 receiving a text prompt 602 from a client device 600. As shown in FIG. 6, the text prompt 602 includes multiple concepts (e.g., a first text concept 604 and a second text concept 606). Further, the text-to-image enhancement system 102 processes the text prompt 602 with a diffusion neural network 608 finetuned according to the designed loss function discussed above.

As shown in FIG. 6, the text-to-image enhancement system 102 generates a text-conditioned image 610 from the text prompt 602. In one or more embodiments, the text-conditioned image 610 includes the text-to-image enhancement system 102 generating or modifying a digital image based on the text prompt 602. For instance, the text-to-image enhancement system 102 conditions the generation of a digital image with the text prompt 602. Further, the text-conditioned image 610 distinctly includes multiple concepts from the text prompt 602. To illustrate, for the text prompt that recites “a basketball hoop, a basketball, and a playground,” the text text-conditioned image distinctly depicts a basketball hoop, a basketball, and a playground all within the digital image.

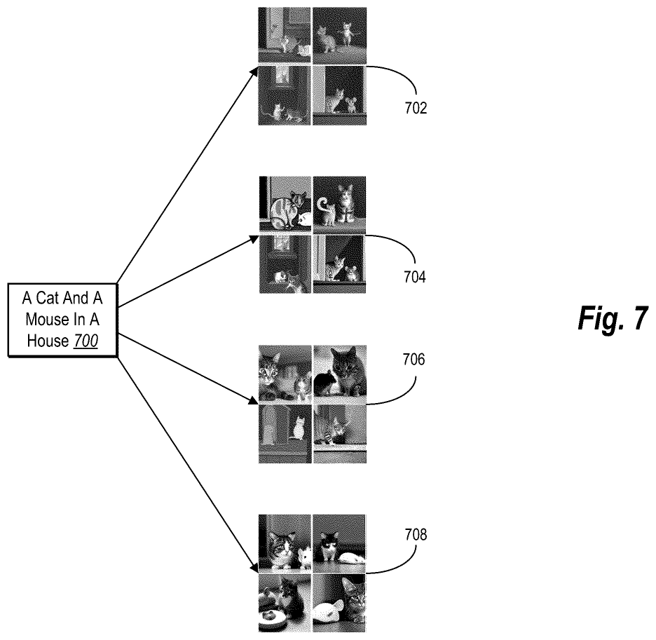

As mentioned above, the text-to-image enhancement system 102 enhances the generation of text-conditioned images, specifically, the text-to-image enhancement system 102 demonstrates qualitative and quantitative improvements of prior methods. For example, FIG. 7 shows a comparison between text-conditioned images generated by the text-to-image enhancement system 102 and images generated by prior systems in accordance with one or more embodiments.

For example, FIG. 7 shows a text prompt 700 “a cat and a mouse in a house.” FIG. 7 also shows text-conditioned images 702 generated from the text-to-image enhancement system 102 versus text-conditioned images 704-708 generated by prior methods. Moreover, in one or more embodiments, the text-conditioned images 702 generated by the text-to-image enhancement system 102 implements the finetuned diffusion neural network which takes three seconds to render an image (e.g., in response to receiving the text prompt 700).

For instance, FIG. 7 shows that visually, the text-conditioned images 702 show distinct textures and also distinctly portrays a cat and a mouse within a house, which conforms with the text prompt 700. Moreover, the prior methods (e.g., text-conditioned images 704-708) show results with inconsistent looking images and the text-conditioned images 706 even misunderstands the context of mouse (e.g., by using a computer mouse).

In one or more embodiments, the text-to-image enhancement system 102 prepares a diffusion neural network with two hundred denoising steps. Furthermore, in some embodiments, for finetuning the denoising steps, the text-to-image enhancement system 102 randomly selects one or more denoising steps out of the two hundred denoising steps. Moreover, in some embodiments, the text-to-image enhancement system 102 determines a measure of loss for a specific denoising step and applies the measure of loss to a cross-attention unit of the denoising step (e.g., applies the measure of loss to the output of the stable diffusion unit).

Moreover, in one or more embodiments, experimenters further evaluate the quantitative aspects of the text-to-image enhancement system 102. For example, experimenters utilize a pre-trained BLIP image captioning model described in Junnan Li, Dongxu Li, Caiming Xiong, and Steven Hoi. Blip: Bootstrapping language-image pre-training for unified vision-language understanding and generation. arXiv preprint arXiv:2201.12086, 2022, which is fully incorporated herein by reference. In some such embodiments, the experimenters computed an average CLIP similarity score between the text prompt 700 and all generated captions for the text-conditioned images 702-708. For instance, the experimenters utilize the CLIP model to generate embeddings for the text prompt 700 and the text-conditioned images 702-708 and calculates a cosine similarity between them. Moreover, experimenters found that the text-to-image enhancement system 102 outperformed the prior methods in terms of having a higher similarity score between the BLIP generated captions and the text prompts utilized by experimenters. Accordingly, the text-to-image enhancement system 102 demonstrates superior performance both qualitatively and quantitatively as compared to prior methods.

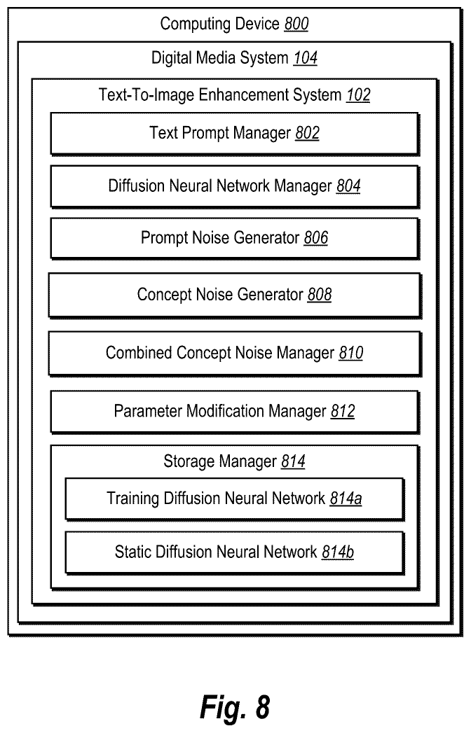

Turning to FIG. 8, additional detail will now be provided regarding various components and capabilities of the text-to-image enhancement system 102. In particular, FIG. 8 illustrates an example schematic diagram of a computing device 800 (e.g., the server(s) 106 and/or the client device 110) implementing the text-to-image enhancement system 102 in accordance with one or more embodiments of the present disclosure for components 800-812. As illustrated in FIG. 8, the text-to-image enhancement system 102 includes a text prompt manager 802, a diffusion neural network manager 804, a prompt noise generator 806, a concept noise generator 808, a combined concept noise manager 810, and a parameter modification manager 812.

The text prompt manager 802 receives a text prompt for training purposes or during inference of the diffusion neural network. For example, the text prompt manager 802 provides an input option within a graphical user interface to input free-form text. In particular, the text prompt manager 802 provides the input option, receives the input option, and further prepares the text prompt for processing by the diffusion neural network. For instance, the text prompt manager 802 can identify multiple concepts within a text prompt and extract each of the multiple concepts (e.g., a first text concept and a second text concept).

The diffusion neural network manager 804 manages diffusion neural network(s) utilized by the text-to-image enhancement system 102. For example, the diffusion neural network manager 804 provides either a static diffusion neural network and training diffusion neural network to the text-to-image enhancement system 102 or provides a single diffusion neural network. Further, the diffusion neural network manager 804 manages the generation of noise representations utilizing diffusion neural networks. Moreover, the diffusion neural network manager 804 manages the training of diffusion neural networks (e.g., stable diffusion neural networks and DDPM) and provides the trained diffusion neural networks to the text-to-image enhancement system 102 for further finetuning.

The prompt noise generator 806 receives the text prompt as a whole from the text prompt manager 802. For example, the prompt noise generator 806 receives the text prompt and generates a prompt noise representation from the text prompt. Specifically, when the text prompt contains multiple concepts, the prompt noise generator 806 generates the prompt noise representation that represents each of the multiple concepts. Accordingly, the prompt noise generator 806 works in tandem with the diffusion neural network manager 804.

The concept noise generator 808 generates noise representations for individual text concepts within the text prompt. For example, the concept noise generator 808 receives extracted text concepts from the text prompt manager 802 and processes the extracted text concepts to generate noise representations for each individual text concept. Specifically, the concept noise generator 808 generates a first concept noise representation from a first text concept and a second concept noise representation from a second text concept.

The combined concept noise manager 810 combines individual concept noise representations to generate a combined concept noise representation. For example, the combined concept noise manager 810 receives the first concept noise representation and the second concept noise representation from the concept noise generator 808 and adds (e.g., concatenates) the concept noise representations to generate the combined noise representation version. Moreover, the combined concept noise manager 810 collaborates with the parameter modification manager 812 to determine a measure of loss based on the combined concept noise representation.

The parameter modification manager 812 modifies parameters of the diffusion neural network. For example, the parameter modification manager 812 receives the combined concept noise representation from the combined concept noise manager 810 and compares it with the prompt noise representation received from the prompt noise generator 806. Moreover, the parameter modification manager 812 determines a measure of loss from the comparison and modifies parameters of the diffusion neural network by backpropagating the measure of loss to one or more denoising layers.

As shown, the text-to-image enhancement system 102 also includes a storage manager 814. The storage manager 814 (e.g., implemented by one or more memory devices) maintains data to perform one or more functions of the text-to-image enhancement system 102. For example, the storage manager 814 includes a static diffusion neural network 814a (e.g., the static diffusion neural network 500) and a training diffusional neural network 814b (e.g., the training diffusion neural network 514). In one or more implementations, the storage manager 814 also stores other digital data, such as text prompts, concepts, and/or digital images,

Each of the components 802-814 of the text-to-image enhancement system 102 can include software, hardware, or both. For example, the components 802-814 can include one or more instructions stored on a computer-readable storage medium and executable by processors of one or more computing devices, such as a client device or server device. When executed by the one or more processors, the computer-executable instructions of the text-to-image enhancement system 102 can cause the computing device(s) to perform the methods described herein. Alternatively, the components 802-814 can include hardware, such as a special-purpose processing device to perform a certain function or group of functions. Alternatively, the components 802-814 of the text-to-image enhancement system 102 can include a combination of computer-executable instructions and hardware.

Furthermore, the components 802-814 of the text-to-image enhancement system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 802-814 of the text-to-image enhancement system 102 may be implemented as a stand-alone application, such as a desktop or mobile application. Furthermore, the components 802-814 of the text-to-image enhancement system 102 may be implemented as one or more web-based applications hosted on a remote server. Alternatively, or additionally, the components 802-814 of the text-to-image enhancement system 102 may be implemented in a suite of mobile device applications or “apps.” For example, in one or more embodiments, the text-to-image enhancement system 102 can comprise or operate in connection with digital software applications such as ADOBE CREATIVE CLOUD EXPRESS, ADOBE PHOTOSHOP, ADOBE ILLUSTRATOR, ADOBE PREMIERE, ADOBE INDESIGN, and/or ADOBE EXPERIENCE CLOUD. The foregoing are either registered trademarks or trademarks of Adobe Inc. in the United States and/or other countries.

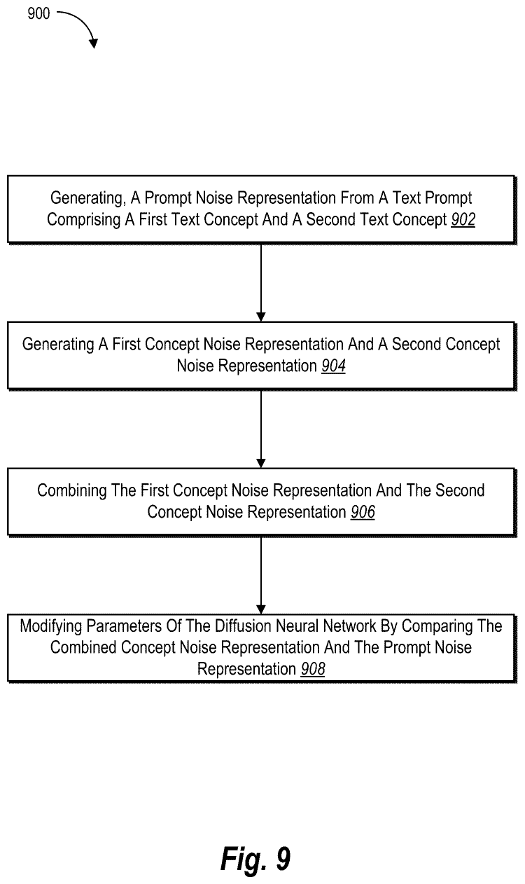

FIGS. 1-8, the corresponding text, and the examples provide a number of different methods, systems, devices, and non-transitory computer-readable media of the text-to-image enhancement system 102. In addition to the foregoing, one or more embodiments can also be described in terms of flowcharts comprising acts for accomplishing the particular result, as shown in FIG. 9. FIG. 9 may be performed with more or fewer acts. Further, the acts may be performed in different orders. Additionally, the acts described herein may be repeated or performed in parallel with one another or in parallel with different instances of the same or similar acts.

FIG. 9 illustrates a flowchart of a series of acts 900 for modifying parameters of a diffusion neural network in accordance with one or more embodiments. FIG. 9 illustrates acts according to one embodiment, alternative embodiments may omit, add to, reorder, and/or modify any of the acts shown in FIG. 9. In some implementations, the acts of FIG. 9 are performed as part of a method. For example, in some embodiments, the acts of FIG. 9 are performed as part of a computer-implemented method. Alternatively, a non-transitory computer-readable medium can store instructions thereon that, when executed by at least one processor, cause a computing device to perform the acts of FIG. 9. In some embodiments, a system performs the acts of FIG. 9. For example, in one or more embodiments, a system includes at least one memory device. The system further includes at least one server device configured to cause the system to perform the acts of FIG. 9.

The series of acts 900 includes an act 902 of generating, a prompt noise representation from a text prompt comprising a first text concept and a second text concept, an act 904 of generating a first concept noise representation and a second concept noise representation, an act 906 of combining the first concept noise representation and the second concept noise representation, and an act 908 of modifying parameters of the diffusion neural network by comparing the combined concept noise representation and the prompt noise representation.

In particular, the act 902 includes generating, utilizing a denoising step of a diffusion neural network, a prompt noise representation from a text prompt comprising a first text concept and a second text concept. Further, the act 904 includes generating a first concept noise representation from the first text concept and a second concept noise representation from the second text concept. Moreover, the act 906 includes combining the first concept noise representation and the second concept noise representation to generate a combined concept noise representation. Further, the act 908 includes modifying parameters of the diffusion neural network by comparing the combined concept noise representation and the prompt noise representation from the text prompt.

For example, in one or more embodiments, the series of acts 900 includes selecting the denoising step of the diffusion neural network from a plurality of denoising steps to generate the prompt noise representation from the text prompt. In addition, in one or more embodiments, the series of acts 900 includes generating a third concept noise representation from a third text concept included within the text prompt. Further, in one or more embodiments, the series of acts 900 includes combining the first concept noise representation, the second concept noise representation, and the third concept noise representation to generate the combined concept noise representation.

Moreover, in one or more embodiments, the series of acts 900 includes conditioning the denoising step of the diffusion neural network with the text prompt. Additionally, in one or more embodiments, the series of acts 900 includes utilizing an additional diffusion neural network by conditioning a denoising step of the additional diffusion neural network with the first text concept and the second text concept.

Furthermore, in one or more embodiments, the series of acts 900 includes selecting, an additional denoising step of the diffusion neural network from a plurality of denoising steps. Additionally, in one or more embodiments, the series of acts 900 includes generating, utilizing the additional denoising step of the diffusion neural network, an additional prompt noise representation from an additional text prompt comprising a third text concept and a fourth text concept.

Moreover, in one or more embodiments, the series of acts 900 includes generating, utilizing the additional denoising step of the diffusion neural network, a third concept noise representation and a fourth concept noise representation. Furthermore, in one or more embodiments, the series of acts 900 includes generating an additional combined concept noise representation by combining the third concept noise representation and the fourth concept noise representation. Additionally, in one or more embodiments, the series of acts 900 includes modifying the parameters of the diffusion neural network by comparing the additional combined concept noise representation and the additional prompt noise representation.

In addition, in one or more embodiments, the series of acts 900 includes identifying a text prompt comprising multiple text concepts from a client device. Further, in one or more embodiments, the series of acts 900 includes generating, utilizing the diffusion neural network with the parameters modified, a digital image comprising the multiple text concepts.

Moreover, in one or more embodiments, the series of acts 900 includes extracting a first text concept and a second text concept from a text prompt. Furthermore, in one or more embodiments, the series of acts 900 includes generating, utilizing a static diffusion neural network, a first concept noise representation by conditioning the static diffusion neural network with the first text concept from the text prompt. Moreover, in one or more embodiments, the series of acts 900 includes generating, utilizing the static diffusion neural network, a second concept noise representation by conditioning the static diffusion neural network utilizing the second text concept from the text prompt. Additionally, in one or more embodiments, the series of acts 900 includes generating, utilizing a training diffusion neural network, a prompt noise representation by conditioning the training diffusion neural network on the text prompt. Further, in one or more embodiments, the series of acts 900 includes modifying parameters of the training diffusion neural network by comparing the prompt noise representation, the first concept noise representation, and the second concept noise representation.

Additionally, in one or more embodiments, the series of acts 900 includes selecting a denoising step of the static diffusion neural network from a plurality of denoising steps. Moreover, in one or more embodiments, the series of acts 900 includes utilizing the selected denoising step of the static diffusion neural network to generate the first concept noise representation and the second concept noise representation. Further, in one or more embodiments, the series of acts 900 includes selecting a denoising step of the training diffusion neural network that corresponds with the denoising step of the static diffusion neural network. Additionally, in one or more embodiments, the series of acts 900 includes generating, utilizing the denoising step of the training diffusion neural network, the prompt noise representation.

Moreover, in one or more embodiments, the series of acts 900 includes combining the first concept noise representation and the second concept noise representation to generate a combined concept noise representation. Further, in one or more embodiments, the series of acts 900 includes modifying the parameters of the training diffusion neural network by comparing the prompt noise representation and the combined concept noise representation.

Additionally, in one or more embodiments, the series of acts 900 includes utilizing a loss function to determine a measure of loss to backpropagate through one or more denoising steps of the training diffusion neural network. Further, in one or more embodiments, the series of acts 900 includes applying a stop gradient operation to a denoising step of the static diffusion neural network utilized to generate the first concept noise representation and the second concept noise representation. Moreover, in one or more embodiments, the series of acts 900 includes generating a trained diffusion neural network by modifying the parameters of the training diffusion neural network. Further, in one or more embodiments, the series of acts 900 includes identifying a text prompt comprising a third text concept and a fourth text concept from a client device. Additionally, in one or more embodiments, the series of acts 900 includes generating, utilizing the trained diffusion neural network, a digital image comprising the third text concept and the fourth text concept.

Moreover, in one or more embodiments, the series of acts 900 includes generating a third concept noise representation from a third text concept included within the text prompt. Further, in one or more embodiments, the series of acts 900 includes combining the first concept noise representation, the second concept noise representation, and the third concept noise representation. Additionally, in one or more embodiments, the series of acts 900 includes conditioning the denoising step of the diffusion neural network with the text prompt. Further, in one or more embodiments, the series of acts 900 includes generating, utilizing an additional diffusion neural network, the first concept noise representation and the second concept noise representation by conditioning a denoising step of the additional diffusion neural network with the first text concept and the second text concept.

Additionally, in one or more embodiments, the series of acts 900 includes generating a trained diffusion neural network by modifying the parameters of the diffusion neural network. Further, in one or more embodiments, the series of acts 900 includes identifying a text prompt comprising multiple text concepts from a client device. Moreover, in one or more embodiments, the series of acts 900 includes generating, utilizing the trained diffusion neural network, a digital image comprising the multiple text concepts.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of an example computing device 1000 that may be configured to perform one or more of the processes described above. One will appreciate that one or more computing devices, such as the computing device 1000 may represent the computing devices described above (e.g., the server(s) 106 and/or the client device 110). In one or more embodiments, the computing device 1000 may be a mobile device (e.g., a mobile telephone, a smartphone, a PDA, a tablet, a laptop, a camera, a tracker, a watch, a wearable device). In some embodiments, the computing device 1000 may be a non-mobile device (e.g., a desktop computer or another type of client device). Further, the computing device 1000 may be a server device that includes cloud-based processing and storage capabilities.

As shown in FIG. 10, the computing device 1000 can include one or more processor(s) 1002, memory 1004, a storage device 1006, input/output interfaces 1008 (or “I/O interfaces 1008”), and a communication interface 1010, which may be communicatively coupled by way of a communication infrastructure (e.g., bus 1012). While the computing device 1000 is shown in FIG. 10, the components illustrated in FIG. 10 are not intended to be limiting. Additional or alternative components may be used in other embodiments. Furthermore, in certain embodiments, the computing device 1000 includes fewer components than those shown in FIG. 10. Components of the computing device 1000 shown in FIG. 10 will now be described in additional detail.

In particular embodiments, the processor(s) 1002 includes hardware for executing instructions, such as those making up a computer program. As an example, and not by way of limitation, to execute instructions, the processor(s) 1002 may retrieve (or fetch) the instructions from an internal register, an internal cache, memory 1004, or a storage device 1006 and decode and execute them.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1004 may be internal or distributed memory.

The computing device 1000 includes a storage device 1006 including storage for storing data or instructions. As an example, and not by way of limitation, the storage device 1006 can include a non-transitory storage medium described above. The storage device 1006 may include a hard disk drive (HDD), flash memory, a Universal Serial Bus (USB) drive or a combination these or other storage devices.

As shown, the computing device 1000 includes one or more I/O interfaces 1008, which are provided to allow a user to provide input to (such as user strokes), receive output from, and otherwise transfer data to and from the computing device 1000. These I/O interfaces 1008 may include a mouse, keypad or a keyboard, a touch screen, camera, optical scanner, network interface, modem, other known I/O devices or a combination of such I/O interfaces 1008. The touch screen may be activated with a stylus or a finger.

The I/O interfaces 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1008 are configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 provides one or more interfaces for communication (such as, for example, packet-based communication) between the computing device and one or more other computing devices or one or more networks. As an example, and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can include hardware, software, or both that connects components of computing device 1000 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
generating, utilizing a denoising step of a diffusion neural network, a prompt noise representation from a text prompt comprising a first text concept and a second text concept;
generating a first concept noise representation from the first text concept and a second concept noise representation from the second text concept;
combining the first concept noise representation and the second concept noise representation to generate a combined concept noise representation; and
modifying parameters of the diffusion neural network by comparing the combined concept noise representation and the prompt noise representation from the text prompt.

2. The method of claim 1, wherein generating the prompt noise representation further comprises selecting the denoising step of the diffusion neural network from a plurality of denoising steps to generate the prompt noise representation from the text prompt.

3. The method of claim 1, further comprises:
generating a third concept noise representation from a third text concept included within the text prompt; and
combining the first concept noise representation, the second concept noise representation, and the third concept noise representation to generate the combined concept noise representation.

4. The method of claim 1, wherein generating the prompt noise representation further comprises conditioning the denoising step of the diffusion neural network with the text prompt.

5. The method of claim 1, wherein generating the first concept noise representation and the second concept noise representation further comprises utilizing an additional diffusion neural network by conditioning a denoising step of the additional diffusion neural network with the first text concept and the second text concept.

6. The method of claim 1, further comprises:
selecting, an additional denoising step of the diffusion neural network from a plurality of denoising steps; and
generating, utilizing the additional denoising step of the diffusion neural network, an additional prompt noise representation from an additional text prompt comprising a third text concept and a fourth text concept.

7. The method of claim 6, further comprises:
generating, utilizing the additional denoising step of the diffusion neural network, a third concept noise representation and a fourth concept noise representation;
generating an additional combined concept noise representation by combining the third concept noise representation and the fourth concept noise representation; and
modifying the parameters of the diffusion neural network by comparing the additional combined concept noise representation and the additional prompt noise representation.

8. The method of claim 1, further comprises:
identifying a text prompt comprising multiple text concepts from a client device; and
generating, utilizing the diffusion neural network with the parameters modified, a digital image comprising the multiple text concepts.

9. A system comprising:
one or more memory components; and
one or more processing devices coupled to the one or more memory components, the one or more processing devices to perform operations comprising:
extracting a first text concept and a second text concept from a text prompt;
generating, utilizing a static diffusion neural network, a first concept noise representation by conditioning the static diffusion neural network with the first text concept from the text prompt;
generating, utilizing the static diffusion neural network, a second concept noise representation by conditioning the static diffusion neural network utilizing the second text concept from the text prompt;
generating, utilizing a training diffusion neural network, a prompt noise representation by conditioning the training diffusion neural network on the text prompt; and
modifying parameters of the training diffusion neural network by comparing the prompt noise representation, the first concept noise representation, and the second concept noise representation.

10. The system of claim 9, wherein generating the first concept noise representation and the second concept noise representation further comprises:
selecting a denoising step of the static diffusion neural network from a plurality of denoising steps; and
utilizing the selected denoising step of the static diffusion neural network to generate the first concept noise representation and the second concept noise representation.

11. The system of claim 10, wherein the operations further comprise:
selecting a denoising step of the training diffusion neural network that corresponds with the denoising step of the static diffusion neural network; and
generating, utilizing the denoising step of the training diffusion neural network, the prompt noise representation.

12. The system of claim 9, wherein modifying the parameters further comprise:
combining the first concept noise representation and the second concept noise representation to generate a combined concept noise representation; and
modifying the parameters of the training diffusion neural network by comparing the prompt noise representation and the combined concept noise representation.

13. The system of claim 9, wherein comparing the prompt noise representation and a combined concept noise representation from the first concept noise representation, and the second concept noise representation comprises utilizing a loss function to determine a measure of loss to backpropagate through one or more denoising steps of the training diffusion neural network.

14. The system of claim 9, wherein modifying the parameters of the training diffusion neural network further comprise applying a stop gradient operation to a denoising step of the static diffusion neural network utilized to generate the first concept noise representation and the second concept noise representation.

15. The system of claim 9, wherein the operations further comprise:
generating a trained diffusion neural network by modifying the parameters of the training diffusion neural network;
identifying a text prompt comprising a third text concept and a fourth text concept from a client device; and
generating, utilizing the trained diffusion neural network, a digital image comprising the third text concept and the fourth text concept.

16. A non-transitory computer-readable medium storing executable instructions which, when executed by at least one processing device, cause the at least one processing device to perform operations comprising:
generating, utilizing a denoising step of a diffusion neural network, a prompt noise representation from a text prompt comprising a first text concept and a second text concept;
generating a first concept noise representation from the first text concept and a second concept noise representation from the second text concept;
combining the first concept noise representation and the second concept noise representation to generate a combined concept noise representation; and
modifying parameters of the diffusion neural network by comparing the combined concept noise representation and the prompt noise representation from the text prompt.

17. The non-transitory computer-readable medium of claim 16, wherein the operations further comprise generating a third concept noise representation from a third text concept included within the text prompt.

18. The non-transitory computer-readable medium of claim 17, wherein generating the combined concept noise representation comprises combining the first concept noise representation, the second concept noise representation, and the third concept noise representation.

19. The non-transitory computer-readable medium of claim 16, wherein the operations further comprise:
conditioning the denoising step of the diffusion neural network with the text prompt; and
generating, utilizing an additional diffusion neural network, the first concept noise representation and the second concept noise representation by conditioning a denoising step of the additional diffusion neural network with the first text concept and the second text concept.

20. The non-transitory computer-readable medium of claim 16, wherein the operations further comprise:
generating a trained diffusion neural network by modifying the parameters of the diffusion neural network;
identifying a text prompt comprising multiple text concepts from a client device; and
generating, utilizing the trained diffusion neural network, a digital image comprising the multiple text concepts.
